(19) United States
(12) Patent Application Publication
(10) Pub. No.: US 2025/0062587 A1
(43) Pub. Date: Feb. 20, 2025

(54) LASER SYSTEM AND ELECTRONIC DEVICE MANUFACTURING METHOD

(71) Applicant: Gigaphoton Inc., Tochigi (JP)

(72) Inventor: Takayuki OSANAI, Oyama-shi (JP)

(73) Assignee: Gigaphoton Inc., Tochigi (JP)

(21) Appl. No.: 18/939,232

(22) Filed: Nov. 6, 2024

Related U.S. Application Data
(63) Continuation of application No. PCT/JP2022/025091, filed on Jun. 23, 2022.

(51) Int. Cl. H01S 3/108; G02F 1/35; G02F 1/355; G02F 1/39; H01S 3/00; H01S 3/02; H01S 3/102

(52) U.S. Cl. CPC H01S 3/1083; G02F 1/354; G02F 1/3551; G02F 1/392; H01S 3/0092; H01S 3/025; H01S 3/1024

(57) ABSTRACT

A laser system includes a pump laser device outputting pump laser light having a first wavelength, a signal laser device outputting signal laser light having a second wavelength, and an amplification system including optical parametric crystals outputting amplification light. The optical parametric crystals include first and second optical parametric crystals. The amplification system is arranged such that beam waist positions of first amplification light and the pump laser light coincide with each other, and that the first amplification light and the pump laser light are coaxially incident on the second optical parametric crystal; and includes a first beam diameter adjustment optical system in which a ratio of a beam waist diameter of the pump laser light to that of the first amplification light is set larger than a ratio of a beam waist diameter of the pump laser light to that of the signal laser light.

### CROSS-REFERENCE TO RELATED APPLICATIONS

The present application claims the benefit of International Application No. PCT/JP2022/025091, filed on Jun. 23, 2022, the entire contents of which are hereby incorporated by reference.

### BACKGROUND

### 1. Technical Field

The present disclosure relates to a laser system and an electronic device manufacturing method.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser device for exposure, a KrF excimer laser device for outputting laser light having a wavelength of about 248 nm and an ArF excimer laser device for outputting laser light having a wavelength of about 193 nm are used.

The KrF excimer laser device and the ArF excimer laser device each have a large spectral line width of about 350 to 400 pm in natural oscillation light. Therefore, when a projection lens is formed of a material that transmits ultraviolet rays such as KrF laser light and ArF laser light, there is a case in which chromatic aberration occurs. As a result, the resolution may decrease. Then, a spectral line width of laser light output from the gas laser device needs to be narrowed to the extent that the chromatic aberration can be ignored. For this purpose, there is a case in which a line narrowing module (LNM) including a line narrowing element (etalon, grating, and the like) is provided in a laser resonator of the gas laser device to narrow a spectral line width. In the following, a gas laser device with a narrowed spectral line width is referred to as a line narrowing gas laser device.

### LIST OF DOCUMENTS

### Patent Documents

Patent Document 1: U.S. Pat. No. 6,208,458
Patent Document 2: Japanese Patent Application Publication No. 2001-27771
Patent Document 3: Japanese Patent Application Publication No. 2010-66381

### SUMMARY

A laser system according to an aspect of the present disclosure includes a pump laser device configured to output pump laser light having a first wavelength, a signal laser device configured to output signal laser light having a second wavelength longer than the first wavelength, and an amplification system including a plurality of optical parametric crystals configured to transmit the pump laser light and the signal laser light and output amplification light having the second wavelength. Here, the plurality of optical parametric crystals includes a first optical parametric crystal and a second optical parametric crystal arranged in series with the first optical parametric crystal. The amplification system is arranged such that beam waist positions of first amplification light, output from the first optical parametric crystal, incident on the second optical parametric crystal, and having the second wavelength and the pump laser light incident on the second optical parametric crystal coincide with each other, and that the first amplification light and the pump laser light are coaxially incident on the second optical parametric crystal; and includes a first beam diameter adjustment optical system in which a ratio of a beam waist diameter of the pump laser light in the second optical parametric crystal with respect to a beam waist diameter of the first amplification light in the second optical parametric crystal is set larger than a ratio of a beam waist diameter of the pump laser light in the first optical parametric crystal with respect to a beam waist diameter of the signal laser light in the first optical parametric crystal.

An electronic device manufacturing method according to another aspect of the present disclosure includes generating laser light having a second wavelength using a laser system, generating ultraviolet laser light by performing wavelength conversion on the laser light having the second wavelength, outputting the ultraviolet laser light to an exposure apparatus, and exposing a photosensitive substrate to the ultraviolet laser light in the exposure apparatus to manufacture an electronic device. Here, the laser system includes a pump laser device configured to output pump laser light having a first wavelength, a signal laser device configured to output signal laser light having the second wavelength longer than the first wavelength, and an amplification system including a plurality of optical parametric crystals configured to transmit the pump laser light and the signal laser light and output amplification light having the second wavelength. The plurality of optical parametric crystals includes a f first optical parametric crystal and a second optical parametric crystal arranged in series with the first optical parametric crystal. The amplification system is arranged such that beam waist positions of first amplification light, output from the first optical parametric crystal, incident on the second optical parametric crystal, and having the second wavelength and the pump laser light incident on the second optical parametric crystal coincide with each other, and that the first amplification light and the pump laser light are coaxially incident on the second optical parametric crystal; and includes a first beam diameter adjustment optical system in which a ratio of a beam waist diameter of the pump laser light in the second optical parametric crystal with respect to a beam waist diameter of the first amplification light in the second optical parametric crystal is set larger than a ratio of a beam waist diameter of the pump laser light in the first optical parametric crystal with respect to a beam waist diameter of the signal laser light in the first optical parametric crystal.

### BRIEF DESCRIPTION OF THE DRAWINGS

Embodiments of the present disclosure will be described below merely as examples with reference to the accompanying drawings.

FIG. 1 schematically shows an exemplary configuration of a solid state laser system.

FIG. 2 schematically shows the configuration of an amplification system in the solid state laser system.

FIG. 3 schematically shows a configuration example of a beam diameter adjustment optical system.

FIG. 4 is an explanatory diagram schematically showing propagation of laser light at the inside of optical parametric crystals of the amplification system applied to a laser system according to the comparative example and in the vicinity of entrance and exit portions thereof.

FIG. 5 is an explanatory diagram schematically showing propagation of laser light at the inside of the optical parametric crystals of the amplification system applied to the laser system according to a first embodiment and in the vicinity of the entrance and exit portions thereof.

FIG. 6 schematically shows the configuration of the amplification system applied to the laser system according to a second embodiment.

FIG. 7 schematically shows a first modification of the beam diameter adjustment optical system.

FIG. 8 schematically shows a second modification of the beam diameter adjustment optical system.

FIG. 9 schematically shows the configuration of an exposure apparatus.

### DESCRIPTION OF EMBODIMENTS

### Contents

1. Description of solid state laser system
   1.1 Configuration
   1.2 Operation
   1.3. Description of amplification system
      1.3.1 Configuration
      1.3.2 Operation
2. Problem
3. First Embodiment
   3.1 Configuration
   3.2 Operation
   3.3 Basis of condition of beam waist diameter ratio
      3.3.1 Calculation of divergence angle ratio
      3.3.2 Calculation of pump laser light utilization efficiency
   3.4 Effect
4. Second Embodiment
   4.1 Configuration
   4.2 Operation
   4.3 Effect
5. First modification of beam diameter adjustment optical system
   5.1 Configuration
   5.2 Operation
   5.3 Effect
   5.4 Control example
6. Second modification of beam diameter adjustment optical system
7. Laser system using excimer amplifier
8. Electronic device manufacturing method
9. Others

Hereinafter, embodiments of the present disclosure will be described in detail with reference to the drawings. The embodiments described below show some examples of the present disclosure and do not limit the contents of the present disclosure. Also, all configurations and operation described in the embodiments are not necessarily essential as configurations and operation of the present disclosure. Here, the same components are denoted by the same reference numeral, and duplicate description thereof is omitted.

### 1. Description of Solid State Laser System

### 1.1 Configuration

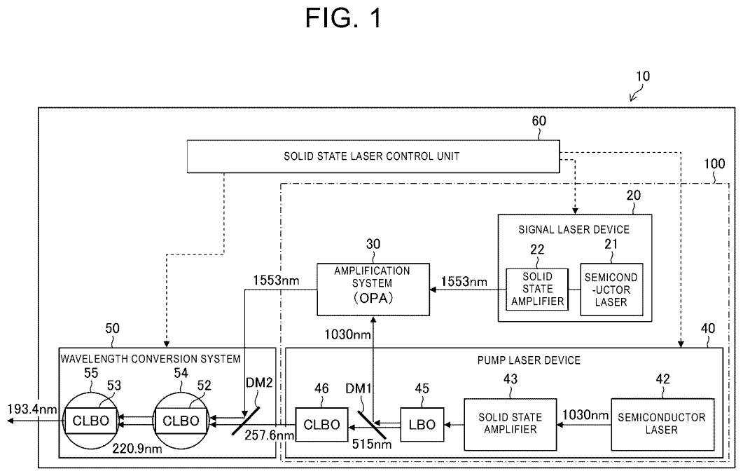

FIG. 1 schematically shows an exemplary configuration of a solid state laser system 10.

The solid state laser system 10 includes a laser system 100 including a signal laser device 20, an amplification system 30, and a pump laser device 40, a wavelength conversion system 50, and a solid state laser control unit 60. The solid state laser system 10 outputs pulse laser light having a wavelength of about 1553 nm and pulse laser light having a wavelength of about 257.6 nm from the laser system 100, and inputs both pulse laser light to the wavelength conversion system 50 to perform wavelength conversion, thereby outputting pulse laser light having a wavelength of about 193.4 nm.

The signal laser device 20 includes a semiconductor laser 21 and a solid state amplifier 22. The semiconductor laser 21 performs continuous wave (CW) oscillation in a single longitudinal mode at a wavelength of about 1553 nm.

The solid state amplifier 22 includes a semiconductor optical amplifier (SOA) that amplifies the CW oscillation laser light output from the semiconductor laser 21.

The pump laser device 40 includes a semiconductor laser 42, a solid state amplifier 43, an LBO crystal 45 and a CLBO crystal 46 that are nonlinear optical crystals, and a dichroic mirror DM1. “LBO” is represented by the chemical formula LiB₃O₅. “CLBO” is represented by the chemical formula CsLiB₆O₁₀.

The semiconductor laser 42 performs CW oscillation in a single longitudinal mode at a wavelength of about 1030 nm. The solid state amplifier 43 is an amplifier including an SOA, and a Yb fiber amplifier or a Yb:YAG crystal.

Due to the combination of the two nonlinear optical crystals of the LBO crystal 45 and the CLBO crystal 46, wavelength-conversion of the wavelength of about 1030 nm to fourth harmonic light (wavelength of about 257.6 nm) is performed.

The dichroic mirror DM1 is arranged on an optical path between the LBO crystal 45 and the CLBO crystal 46, and highly transmits pulse laser light having a wavelength of about 515 nm and highly reflects pulse laser light having a wavelength of about 1030 nm. The pulse laser light having a wavelength of about 1030 nm and highly reflected by the dichroic mirror DM1 enters the amplification system 30 as pump laser light.

The amplification system 30 includes an optical parametric amplifier (OPA). The OPA is, for example, an amplifier including a periodically poled lithium niobate (PPLN) crystal or a periodically poled potassium titanyl phosphate (PPKTP) crystal. By receiving the pump laser light and the signal laser light, the OPA performs pulse amplification on the signal laser light.

The wavelength conversion system 50 includes a dichroic mirror DM2, two CLBO crystals 52, 53, and two rotation stages 54, 55 that change the incident angles of the CLBO crystals 52, 53, respectively. The CLBO crystals 52, 53 are arranged on the rotation stages 54, 55 each including a piezoelectric element (not shown), and are configured to be capable of changing the incident angles on the crystals at high speed.

The dichroic mirror DM2 is configured to highly reflect the pulse laser light having a wavelength of about 1533 nm output from the amplification system 30 and to highly transmit the pulse laser light having a wavelength of about 257.6 nm output from the CLBO crystal 46 of the pump laser device 40, and is arranged so that both pulse laser light are incident on the CLBO crystal 52 coaxially.

The CLBO crystals 52, 53 are arranged in series and generate pulse laser light having a wavelength of about 193.4 nm by two times of sum frequency generation.

The solid state laser control unit 60 is connected to the signal laser device 20, the pump laser device 40, and the wavelength conversion system 50, and includes a processor (not shown). The processor is a processing device configured to include a central processing unit (CPU) (not shown) and a memory (not shown). The processor may include a graphics processing unit (GPU). The processor is specifically configured or programmed to perform various processes included in the present disclosure.

### 1.2 Operation

The solid state laser control unit 60 controls a current value of the semiconductor laser 42 of the pump laser device 40 to cause CW oscillation, and causes semiconductor laser 42 to output CW laser light having a wavelength of about 1030 nm. Further, the solid state laser control unit 60 pulses the CW laser light at the SOA of the solid state amplifier 43, and performs pulse amplification by the amplifier including a Yb fiber amplifier or a Yb:YAG crystal of the solid state amplifier 43.

The LBO crystal 45 converts the pulse laser light having a wavelength of about 1030 nm into second harmonic light having a wavelength of about 515 nm. The second harmonic light having a wavelength of about 515 nm is highly transmitted through the dichroic mirror DM1, and is further converted by the CLBO crystal 46 into pulse laser light which is ultraviolet light having a wavelength of about 257.6 nm.

Here, the dichroic mirror DM1 highly reflects the pulse laser light having a wavelength of about 1030 nm which has not been wavelength-converted by the LBO crystal 45, and causes the pulse laser light to enter the OPA as the pump laser light of the amplification system 30.

Further, the solid state laser control unit 60 controls a current value of the semiconductor laser 21 of the signal laser device 20 to cause the signal laser device 20 to output CW laser light having a wavelength of about 1553 nm. Further, the solid state laser control unit 60 causes the solid state amplifier 22 to perform amplification, and causes the signal laser device 20 to output the CW laser light having a wavelength of about 1553 nm.

The OPA of the amplification system 30 receives the pulse laser light having a wavelength of about 1030 nm reflected by the dichroic mirror DM1 as the pump laser light, and the CW laser light having a wavelength of about 1553 nm output from the signal laser device 20 as the signal laser light, and outputs amplified pulse laser light having a wavelength of about 1553 nm.

The pulse laser light having a wavelength of about 1553 nm output from the amplification system 30 and the pulse laser light having a wavelength of about 257.6 nm output from the pump laser device 40 are both input to the wavelength conversion system 50. The pulse laser light reflected by the dichroic mirror DM2 having a wavelength of about 1553 nm and the pulse laser light transmitted through the dichroic mirror DM2 having a wavelength of about 257.6 nm are incident on the CLBO crystal 52 coaxially. Then, after sum frequency generation is caused by the CLBO crystal 52 so that wavelength conversion to a wavelength of about 220.9 nm is performed, pulse laser light having a wavelength of about 193.4 nm is output by sum frequency with the pulse laser light having a wavelength of about 1553 nm in the CLBO crystal 53.

The respective incident angles on the CLBO crystals 52, 53 may be adjusted by the solid state laser control unit 60 to compensate for wavelength conversion efficiency.

### 1.3. Description of Amplification System

### 1.3.1 Configuration

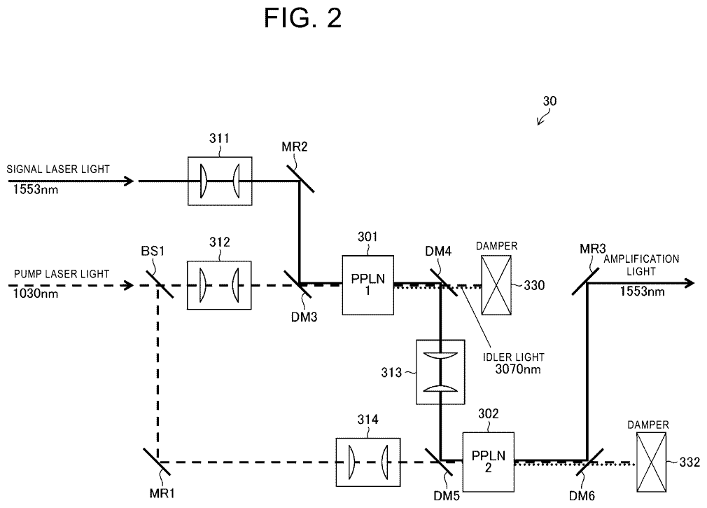

FIG. 2 schematically shows the configuration of the amplification system 30. The amplification system 30 includes a plurality of PPLN crystals 301, 302, beam diameter adjustment optical systems 311 to 314, dichroic mirrors DM3 to DM6, dampers 330, 332, a beam splitter BS1, and mirrors MR1 to MR3 for optical path formation.

The beam diameter adjustment optical systems 311, 312 are configured such that the beam waist diameters, in the PPLN crystal 301, of the signal laser light and the pump laser light incident on the PPLN crystal 301 are substantially the same. The beam diameter adjustment optical system 311 is arranged on the optical path of the signal laser light, and the beam diameter adjustment optical system 312 is arranged on the optical path of the pump laser light.

The beam diameter adjustment optical systems 313, 314 are configured such that the beam waist diameters, in the PPLN crystal 302, of the signal laser light and the pump laser light incident on the PPLN crystal 302 are substantially the same. The beam diameter adjustment optical system 313 is arranged on the optical path of the signal laser light between the PPLN crystal 301 and the PPLN crystal 302, and the beam diameter adjustment optical system 314 is arranged on the optical path of the pump laser light.

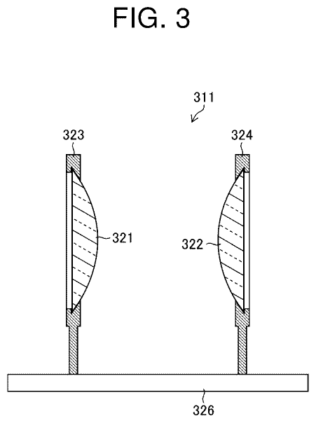

Each of the beam diameter adjustment optical systems 311 to 314 may, for example, be configured to maintain the distance between lenses of an opposing lens pair (see FIG. 3). The beam diameter adjustment optical systems 311 to 314 can adjust the beam waist position and the beam waist diameter of each of the signal laser light and the pump laser light.

The beam splitter BS1 is arranged on the optical path of the pump laser light so as to branch the pump laser light from the pump laser device 40 and cause the pump laser light to enter each of the beam diameter adjustment optical systems 312, 314. The mirror MR1 is arranged to reflect the pump laser light reflected by the beam splitter BS1 and guide the pump laser light to the beam diameter adjustment optical system 314.

The dichroic mirrors DM3, DM5 are dichroic mirrors for combining the signal laser light and the pump laser light and causing the both laser light to be incident on the PPLN crystals 301, 302 coaxially. The dichroic mirrors DM3, DM5 highly reflect light having a wavelength of about 1553 nm and highly transmits light having a wavelength of about 1030 nm, for example. The dichroic mirror DM3 is arranged on the optical path between the beam diameter adjustment optical systems 311, 312 and the PPLN crystal 301. The dichroic mirror DM5 is arranged on the optical path between the beam diameter adjustment optical systems 313, 314 and the PPLN crystal 302. The mirror MR2 is arranged so that the signal laser light output from the beam diameter adjustment optical system 311 is incident on the dichroic mirror DM3.

The dichroic mirrors DM4, DM6 are dichroic mirrors for separating the pump laser light and idler light from output light of the PPLN crystals 301, 302. The dichroic mirrors DM4, DM6 highly reflect the signal laser light having a wavelength of about 1553 nm and highly transmit the pump laser light having a wavelength of about 1030 nm and the idler light having a wavelength of about 3070 nm.

The dampers 330, 332 absorb the pump laser light and the idler light separated by the dichroic mirrors DM4, DM6. The plurality of mirrors MR1 to MR3 are arranged to configure the optical path of the OPA.

FIG. 3 shows a first configuration example of the beam diameter adjustment optical system 311. The beam diameter adjustment optical system 311 includes lenses 321, 322. The lenses 321, 322 are respectively held by the lens holders 323, 324 and arranged on a base plate 326 to face each other. The other beam diameter adjustment optical systems 312 to 314 may have a similar configuration.

### 1.3.2 Operation

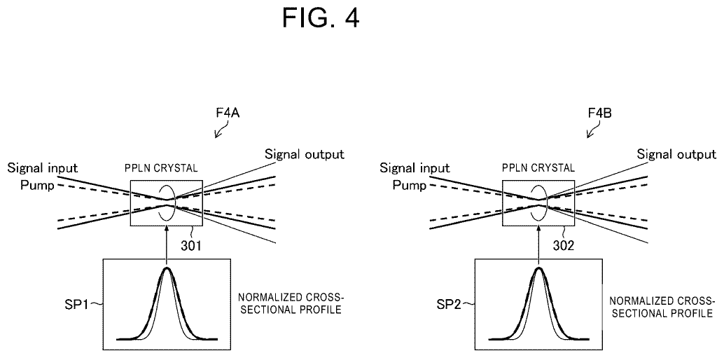

FIG. 4 schematically shows how the signal laser light, the pump laser light, and the amplification light propagate inside the PPLN crystals 301, 302 and in the vicinity of the entrance and exit portions thereof in a cross section including an optical axis of the signal laser light of the amplification system 30 applied to the laser system 100 according to the comparative example. The comparative example of the present disclosure is an example recognized by the applicant as known only by the applicant, and is not a publicly known example admitted by the applicant. Cross-sectional profiles SP1, SP2 respectively attached to left diagram F4A and right diagram F4B of FIG. 4 schematically show cross-sectional intensity distributions of the signal laser light, the pump laser light, and the amplification light at a beam waist position in the corresponding crystal. A horizontal direction of the cross-sectional profiles SP1, SP2 indicates a radial direction of the beam waist, and the vertical direction indicates a normalized intensity.

In FIG. 4, the signal laser light, the pump laser light, and the amplification light for the PPLN crystals 301, 302 are denoted by “Signal input”, “Pump”, and “Signal output”, respectively.

The signal laser light and the pump laser light having entered the amplification system 30 enter the PPLN crystal 301 via the beam diameter adjustment optical systems 311, 312, respectively. At this time, the respective beam waist positions of the signal laser light and the pump laser light incident on the PPLN crystal 301 coincide with each other, and the beam waist diameter, at the inside of the PPLN crystal 301, of the both laser light coaxially incident is set to be substantially the same between the pump laser light and the signal laser light (see left diagram F4A of FIG. 4). When the signal laser light and the pump laser light are incident on the PPLN crystal 301, optical parametric amplification occurs in the PPLN crystal 301, and the amplification light having a wavelength of about 1553 nm which is the same as that of the signal laser light and the idler light having a wavelength (about 3070 nm) corresponding to a difference frequency between the signal laser light and the pump laser light are generated.

The pump laser light and the idler light output from the PPLN crystal 301 are absorbed by the damper 330 via the dichroic mirror DM4.

Light having a wavelength of about 1553 nm including the amplification light and the signal laser light output from the PPLN crystal 301 is incident on the PPLN crystal 302 via the dichroic mirror DM4, the beam diameter adjustment optical system 313, and the dichroic mirror DM5. The laser light output from the PPLN crystal 301 having a wavelength of about 1553 nm becomes the signal laser light input to the PPLN crystal 302.

Further, the pump laser light branched by the beam splitter BS1 is incident on the PPLN crystal 302 via the mirror MR1, the beam diameter adjustment optical system 314, and the dichroic mirror DM5. At this time, the beam waist diameter at the inside of the PPLN crystal 301 is set to be substantially the same between the pump laser light and the signal laser light (see right diagram F4B of FIG. 4). Optical parametric amplification occurs in the PPLN crystal 302, and the amplification light having a wavelength of about 1553 nm which is the same as that of the signal laser light and the idler light having a wavelength (about 3070 nm) corresponding to the difference frequency between the signal laser light and the pump laser light are generated.

The pump laser light and the idler light output from the PPLN crystal 302 are absorbed by the damper 332 via the dichroic mirror DM6. The amplification light and the signal laser light output from the PPLN crystal 302 are used for sum frequency generation in the CLBO crystal 52 of the wavelength conversion system 50 (see FIG. 1).

### 1.3.3 Effect

The beam waist diameter at the inside of each of the PPLN crystals 301, 302 is adjusted to be substantially the same between the pump laser light and the signal laser light. This is because the beam waists having the same diameter is set in the vicinity of the crystal center in order to widen a region at which phase matching can be efficiently performed at the beam waist position at which a beam can be regarded as a plane wave. As a result, mode matching between the signal laser light and the pump laser light is improved, and strong amplification light can be obtained.

### 2. Problem

The output light of the PPLN crystals 301, 302 includes transmission light (transmitted signal laser light) of the input signal laser light in addition to the amplification light and the idler light. To efficiently generate the amplification light as described above, in the amplification system 30 of the comparative example, the beam waist diameter at the inside of the PPLN crystals 301, 302 is set to be substantially the same between the pump laser light and the signal laser light.

Power density of the amplification light is proportional to the product of the power densities of the input signal laser light and the pump laser light. Accordingly, the amplification light has a smaller beam diameter and a larger divergence angle than the input signal laser light at the beam waist. On the other hand, since the input signal laser light is output from the PPLN crystals 301, 302 as it is, light having the same wavelength and two types of divergence angles are output from each of the PPLN crystals 301, 302.

Beam propagation is different between the input signal laser light and the amplification light having the same wavelength and different divergence angles. That is, two beams having the same wavelength, substantially the same power, and different divergence angles propagate coaxially. This may be problematic as the difference in power between the input signal laser light and the amplification beam is small. That is, the following problems may occur.

### Problem

In the optical system at a later stage of the OPA, two beams of light having the same wavelength and different concentration positions are mixed, and a complicated optical system may be required in an application requiring precise concentration or imaging. In particular, it is difficult to adjust beam propagation at later stages in an application in which saturation amplification is approached at later stages, such as multi-stage amplification.

### 3. First Embodiment

### 3.1 Configuration

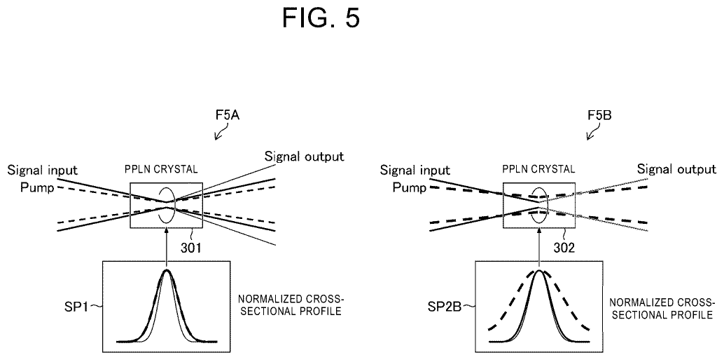

The configuration of the laser system 100 according to a first embodiment may be similar to the configuration shown in FIGS. 1 to 3. FIG. 5 schematically shows propagation of the signal laser light, the pump laser light, and the amplification light at the inside of the PPLN crystals 301, 302 of the amplification system 30 applied to the laser system 100 according to the first embodiment and in the vicinity of the entrance and exit portions thereof. Cross-sectional profiles SP1, SP2B respectively attached to left diagram F5A and right diagram F5B of FIG. 5 schematically show cross-sectional intensity distributions of the signal laser light, the pump laser light, and the amplification light at a beam waist position in the corresponding crystal. A horizontal direction of the cross-sectional profiles SP1, SP2B indicates a radial direction of the beam waist, and the vertical direction indicates the normalized intensity.

The laser system 100 according to the first embodiment is configured to realize beam propagation as shown in FIG. 5, instead of the beam propagation described in FIG. 4. That is, as shown in left diagram F5A of FIG. 5, the beam diameter adjustment optical systems 311, 312 are set so that the beam waists of the pump laser light and the signal laser light locate at a center part of the PPLN crystal 301. Further, the beam waist diameters are set to be substantially the same between the pump laser light and the signal laser light. This point is similar to the comparative example described in left diagram F4A of FIG. 4.

That is, the beam diameter adjustment optical systems 311, 312 are set so that the beam waist positions of the pump laser light and the signal laser light incident on the PPLN crystal 301 coincide with each other, and the beam waist diameters of both are the same at the center part of the PPLN crystal 301. Here, the description of the “center part” of the crystal is not limited to the exact center point, and includes the meaning of the vicinity of the center which can be generally regarded as the center. The description of “coincidence” is not limited to a case of exactly coinciding, but includes the concept of coincidence including an allowable range that can be regarded as substantial coincidence. Further, the description of the beam waist diameters being the “same” is not limited to a case in which the beam waist diameters are exactly the same (equal), and includes the concept of being the same including an allowable range that can be regarded as substantially the same diameter.

Further, in the laser system 100 according to the first embodiment, as shown in right diagram F5B of FIG. 5, the beam diameter adjustment optical systems 313, 314 are adjusted so that the beam waists of the pump laser light and the signal laser light locate at the center part of the PPLN crystal 302.

At this time, the respective beam waist positions of the pump laser light and the signal laser light (amplification light of the PPLN crystal 301) incident on the PPLN crystal 302 are set to coincide with each other at the center part of the PPLN crystal 302, and a ratio of the beam waist diameter of the pump laser light with respect to the beam waist diameter of the signal laser light in the PPLN crystal 302 is set to be larger than a ratio (1 time) of the beam waist diameter of the pump laser light with respect to the beam waist diameter of the signal laser light in the PPLN crystal 301. Accordingly, the beam diameter adjustment optical systems 313, 314 are set so that the beam waist diameter of the pump laser light in the PPLN crystal 302 is in a range of 1.5 to 2.6 times of the beam waist diameter of the signal laser light. The condition of the ratio of the beam waist diameter of the pump laser light with respect to the beam waist diameter of the signal laser light defined here is based on a condition setting of a divergence angle ratio of the transmission signal laser light with respect to the amplification light being 0.8 time or more and 1.2 times or less, and pump laser light utilization efficiency being 25% or more. The basis of the preferable range of the ratio of the beam waist diameters will be described below.

### 3.2 Operation

Optical parametric amplification occurs in the PPLN crystal 301, which is the first stage of the amplification system 30 in which the PPLN crystal 301 and the PPLN crystal 302 are arranged in series, and the amplification light having the same wavelength as the signal laser light is generated. The beam diameter adjustment optical systems 311, 312 are adjusted so that the beam waist diameters of the pump laser light and the signal laser light are the same in the vicinity of the crystal center of the PPLN crystal 301 in order to widen a region at which phase matching can be efficiently performed can be regarded as a plane wave. At this time, the amplification light having a divergence angle larger than that of the signal laser light is generated in the PPLN crystal 301, but the power of the signal laser light transmitted through the PPLN crystal 301 is often much weaker than that of the amplification light. This is because the first stage of the amplification stages in the multi-stage amplification is often set with an emphasis on the amplification gain.

The beam diameter adjustment optical system 313 are set for propagation of the amplification light output from the PPLN crystal 301. Therefore, the transmission signal laser light having a divergence angle different from that of the amplification light is attenuated by vignetting or diffusion. As a result, the light amount of the transmission signal laser light incident on the PPLN crystal 302, which is at the second stage, becomes relatively small to the extent that it can be ignored.

On the other hand, the amplification light output from the PPLN crystal 301 is incident on the PPLN crystal 302 as the signal laser light thereof, and is further amplified by optical parametric amplification. At this time, the amplification light having the same wavelength as the input signal laser light of the PPLN crystal 302 is further generated, but since the beam waist diameter of the pump laser light in the PPLN crystal 302 is adjusted to be 1.5 to 2.6 times of that of the signal laser light, the amplification light output from the PPLN crystal 302 has a divergence angle substantially the same as that of the signal laser light transmitted through the PPLN crystal 302. Here, the signal laser light transmitted through the PPLN crystal 302 has a power that cannot be ignored with respect to the corresponding amplification light. This is because the later stages of the amplification stages in the multistage amplification are often set to use a saturation region of an amplification curve. However, according to the configuration of the first embodiment, the transmission signal laser light of the PPLN crystal 302 and the amplification light of the PPLN crystal 302 can be set to have substantially the same divergence angle.

That is, while the ratio of the beam waist diameter of the pump laser light with respect to the beam waist diameter of the signal laser light in the PPLN crystal 301, which is at the first stage, is about 1 time, the ratio of the beam waist diameter of the pump laser light with respect to the beam waist diameter of the signal laser light (amplification light from the PPLN crystal 301) in the PPLN crystal 302, which is the second stage, is set to be larger as being in a range of 1.5 to 2.6 times. As a result, the transmission signal laser light (amplification light from the PPLN crystal 301) output from the PPLN crystal 302 and the amplification light of the PPLN crystal 302 propagate at substantially the same divergence angle. Other operation is similar to that of the solid state laser system 10 of FIG. 1.

The PPLN crystal 301 is an example of the “first optical parametric crystal” in the present disclosure, and the PPLN crystal 302 is an example of the “second optical parametric crystal” in the present disclosure. The beam diameter adjustment optical system 313 and the beam diameter adjustment optical system 314 correspond to an example of the “first beam diameter adjustment optical system” in the present disclosure. The beam diameter adjustment optical system 311 and the beam diameter adjustment optical system 312 correspond to an example of the “second beam diameter adjustment optical system” in the present disclosure. The beam diameter adjustment optical system 313 is an example of the “third beam diameter adjustment optical system” in the present disclosure, and the beam diameter adjustment optical system 314 is an example of the “fourth beam diameter adjustment optical system” in the present disclosure. The beam diameter adjustment optical system 311 is an example of the “fifth beam diameter adjustment optical system” in the present disclosure, and the beam diameter adjustment optical system 312 is an example of the “sixth beam diameter adjustment optical system” in the present disclosure.

The wavelength of about 1030 nm is an example of the “first wavelength” in the present disclosure, and the wavelength of about 1553 nm is an example of the “second wavelength” in the present disclosure. The semiconductor laser 42 is an example of the “first semiconductor laser” in the present disclosure, and the CW laser light output from the semiconductor laser 42 is an example of the “first CW laser light” in the present disclosure. The semiconductor laser 21 is an example of the “second semiconductor laser” in the present disclosure, and the CW laser light output from the semiconductor laser 21 is an example of the “second CW laser light” in the present disclosure. The solid state amplifier 43 is an example of the “first solid state amplifier” in the present disclosure, and the solid state amplifier 22 is an example of the “second solid state amplifier” in the present disclosure. The amplification light output from the PPLN crystal 301 is an example of the “first amplification light” in the present disclosure, and the amplification light output from the PPLN crystal 302 is an example of the “second amplification light” in the present disclosure. Each of the solid state laser system 10 and the laser system 100 is an example of the “laser system” in the present disclosure.

### 3.3 Basis of Condition of Beam Waist Diameter Ratio

### 3.3.1 Calculation of Divergence Angle Ratio

Here, the basis of the condition that the beam waist diameter of the pump laser light is preferably 1.5 to 2.6 times of the beam waist diameter of the signal laser light will be described.

Beam intensities of the input signal laser light, the pump laser light, and the amplification light of the PPLN crystal are denoted as Iₛ, Iₚ, and Iₐ, respectively, and each light is assumed to be a Gaussian beam having 1/e² radius of wₛ, wₚ, or wₐ at the beam waist. Assuming that the beam intensity Ia of the amplification light is proportional to the product of the beam intensity Is of the input signal laser light and the beam intensity Ip of the pump laser light, a beam intensity distribution Iₐ(x, y) of the amplification light is expressed by the following expression (1).

$$\begin{matrix}[ Expression 1 ] & \\ {I}_{a} ( x , y ) = {I}_{a 0} exp ( - \frac{2 ( {x}^{2} + {y}^{2} )}{{w}_{a}^{2}} ) = {CI}_{s 0} {I}_{p 0} exp ( - \frac{2 ( {x}^{2} + {y}^{2} )}{{w}_{s}^{2}} ) exp ( - \frac{2 ( {x}^{2} + {y}^{2} )}{{w}_{p}^{2}} ) & ( 1 )\end{matrix}$$

The following expression (2) is obtained from expression (1).

$$\begin{matrix}[ Expression 2 ] & \\ {w}_{a} = \frac{{w}_{s} {w}_{p}}{\sqrt{{w}_{s}^{2} + {w}_{p}^{2}}} = {w}_{s} \frac{1}{\sqrt{1 + {( {w}_{p} / {w}_{s} )}^{- 2}}} & ( 2 )\end{matrix}$$

Since a divergence angle θ of a Gaussian beam can be expressed as θ=λ/πw using a wavelength λ and a beam waist diameter w, a ratio between a divergence angle θₐ of the amplification light and a divergence angle θₛ of the signal laser light is expressed by the following expression (3).

$$\begin{matrix}[ Expression 3 ] & \\ \frac{{θ}_{a}}{{θ}_{s}} = \frac{{w}_{s}}{{w}_{a}} = \sqrt{1 + {( {w}_{p} / {w}_{s} )}^{- 2}} & ( 3 )\end{matrix}$$

When a condition to satisfy θₐ/θₛ≤1.2 as an allowable divergence angle ratio is calculated, the following expression (4) is obtained from expression (3).

$$\begin{matrix}[ Expression 4 ] & \\ \frac{{w}_{p}}{{w}_{s}} \geq \frac{1}{\sqrt{{1.2}^{2} - 1}} \approx 1.5 & ( 4 )\end{matrix}$$

Expression 4 shows a condition of the beam waist diameter ratio for the divergence angle ratio to be 1.2 or less, and defines a lower limit value of the beam waist diameter ratio (wₚ/wₛ) which is a ratio of the beam waist diameter of the pump laser light with respect to the beam waist diameter of the signal laser light. On the other hand, since the divergence angle ratio always takes a value of 1 or more from expression (3), the condition that the divergence angle ratio is 0.8 or more is always satisfied.

### 3.3.2 Calculation of Pump Laser Light Utilization Efficiency

An upper limit value of the preferable beam waist diameter ratio is defined from the viewpoint of the pump laser light utilization efficiency. Here, the pump laser light utilization efficiency E is defined as following expression (5).

$$\begin{matrix}[ Expression 5 ] & \\ E = A \frac{{\int }_{- ∞}^{∞} dx {\int }_{- ∞}^{∞} {dyI}_{a} ( x , y )}{{\int }_{- ∞}^{∞} dx {\int }_{- ∞}^{∞} {dyI}_{p} ( x , y )} & ( 5 )\end{matrix}$$

Here, A in expression (5) is determined so that E=1 when wₛ=wₚ. The numerator and the denominator in expression (5) are calculated as in expression (6) and (7), respectively.

$$\begin{matrix}[ Expression 6 ] & \\ {\int }_{- ∞}^{∞} dx {\int }_{- ∞}^{∞} {dyI}_{a} ( x , y ) = {\int }_{- ∞}^{∞} dx {\int }_{- ∞}^{∞} {dyI}_{a 0} exp ( - \frac{2 ( {x}^{2} + {y}^{2} )}{{w}_{a}^{2}} ) = \frac{π}{2} {w}_{a}^{2} {I}_{a 0} & ( 6 )\end{matrix}$$

$$\begin{matrix}[ Expression 7 ] & \\ {\int }_{- ∞}^{∞} dx {\int }_{- ∞}^{∞} {dyI}_{p} ( x , y ) = \frac{π}{2} {w}_{p}^{2} {I}_{p 0} & ( 7 )\end{matrix}$$

Therefore, expression (5) is expressed as following expression (8) from the expression (6) and (7).

$$\begin{matrix}[ Expression 8 ] & \\ E = \frac{{AI}_{a 0}}{{I}_{p 0}} \frac{{w}_{a}^{2}}{{w}_{p}^{2}} = \frac{{AI}_{a 0}}{{I}_{p 0}} \frac{1}{{w}_{p}^{2}} \frac{{w}_{s}^{2} {w}_{p}^{2}}{{w}_{s}^{2} + {w}_{p}^{2}} = \frac{2}{1 + {( {w}_{p} / {w}_{s} )}^{2}} & ( 8 )\end{matrix}$$

When the condition to satisfy E≥0.25 is calculated in expression (8) on an assumption that the allowable range of the pump laser light utilization efficiency E is equal to or more than 25%, expression (9) is obtained.

$$\begin{matrix}[ Expression 9 ] & \\ \frac{{w}_{p}}{{w}_{s}} \leq \sqrt{7} \approx 2.6 & ( 9 )\end{matrix}$$

Expression (9) shows the condition of the beam waist diameter ratio so that the pump laser light utilization efficiency E becomes equal to or more than 25%, and defines the upper limit value of the beam waist diameter ratio (wₚ/wₛ), which is the ratio of the beam waist diameter of the pump laser light with respect to the beam waist diameter of the signal laser light. From expressions (4) and (9), the beam waist diameter ratio (wₚ/wₛ) is preferably equal to or more than 1.5 and equal to or less than 2.6.

### 3.4 Effect

According to the first embodiment, the divergence angles of the signal laser light and the amplification light that have passed through the PPLN 302 crystal are approximately the same, and the beam diameter adjustment at the optical system in the later stage can be easily performed. On the other hand, in the PPLN crystal 301, mode matching between the signal laser light and the pump laser light is improved, and strong amplification light is obtained. Accordingly, efficient multi-stage amplification is facilitated.

### 4. Second Embodiment

### 4.1 Configuration

The amplification system 30 described using FIG. 2 is configured to perform optical parametric amplification in two stages by the two PPLN crystals 301, 302, but may be configured to perform optical parametric amplification in three or more stages. When optical parametric amplification is performed in three or more stages, the beam diameters of the pump laser light and the signal laser light are set to be the same only in the PPLN crystal 301, which is the first stage, and the beam waist diameter of the pump laser light is set to be 1.5 to 2.6 times of the beam waist diameter of the signal laser light in the PPLN crystal 302, which is the second stage, and all PPLN crystals thereafter.

In the plurality of PPLN crystals arranged in series, the beam waist diameters of the signal laser light and the pump laser light may be set to be larger in a PPLN crystal at a relatively later stage. This may be applied when a larger PPLN crystal is arranged at a later stage.

In the later stages of the multi-stage amplification, the power of the signal laser light and the amplification light increases, and the energy density at the beam waist tends to increase. Therefore, it is preferable to select a PPLN crystal having a large cross-sectional area in later stages so that the energy density does not exceed a damage threshold of the PPLN crystal, and to increase the beam waist diameters of the signal laser light and the pump laser light. That is, the cross-sectional area of the PPLN crystal in a plane perpendicular to the optical axes of the signal laser light and the pump laser light at the beam waist is set larger for the PPLN crystal arranged in the later stages than for the PPLN crystal arranged in the earlier stages. Accordingly, in the later stages, the beam waist diameters of the signal laser light and the pump laser light in the PPLN crystal are set large. Here, the beam waist diameter of the pump laser light in each PPLN crystal is set to be 1.5 to 2.6 times of the beam waist diameter of the signal laser light.

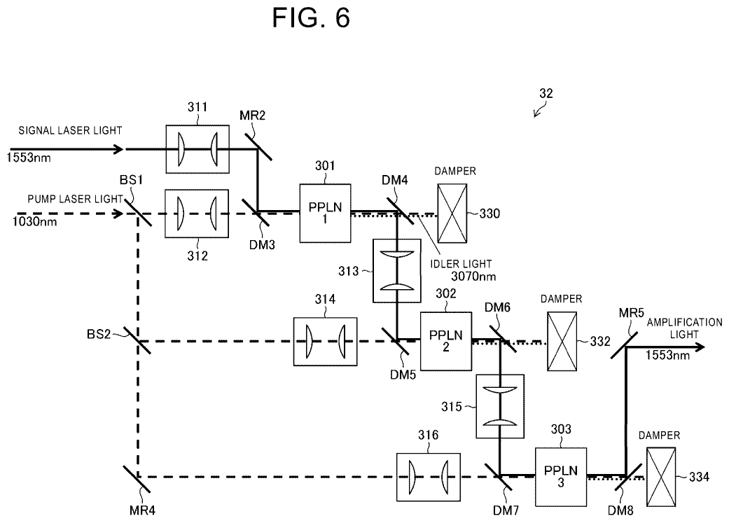

FIG. 6 schematically shows the configuration of an amplification system 32 applied to the laser system 100 according to second the embodiment. Instead of the amplification system 30 described in FIG. 2, the amplification system 32 shown in FIG. 6 may be applied. The amplification system 32 shown in FIG. 6 will be described in terms of differences from the amplification system 30 shown in FIG. 2.

The amplification system 32 is configured to perform three-stage optical parametric amplification with three PPLN crystals 301, 302, 303 arranged in series. That is, in the amplification system 32, a beam diameter adjustment optical system 315, a dichroic mirror DM7, a PPLN crystal 303, a dichroic mirror DM8, and a damper 334 are added in the later stage of the PPLN crystal 302 of FIG. 2. Further, the amplification system 32 includes a beam splitter BS2 in place of the mirror MR1 of FIG. 2, and further includes a mirror MR4 that guides the pump laser light branched by the beam splitter BS2 to the PPLN crystal 303 and a beam diameter adjustment optical system 316.

### 4.2 Operation

Operation up to the second stage of the amplification stages is the same as that in the first embodiment. The amplification light and the transmission signal laser light output from the PPLN crystal 302 and having a wavelength of about 1553 nm become the signal laser light input to the PPLN crystal 303, which is the third stage. The amplification light of the PPLN crystal 302 and the transmission signal laser light transmitted through the PPLN crystal 302 are reflected by the dichroic mirror DM6 and enter the PPLN crystal 303 via the beam diameter adjustment optical system 315 and the dichroic mirror DM7.

Further, the pump laser light transmitted through the beam splitter BS2 is incident, coaxially with the signal laser light, on the PPLN crystal 303 via the mirror MR4, the beam diameter adjustment optical system 316, and the dichroic mirror DM7. As a result, the signal laser light is further amplified by optical parametric amplification in the PPLN crystal 303. At this time, amplification light having the same wavelength as the signal laser light of the PPLN crystal 303 is further generated, but since the pump laser light in the PPLN crystal 303 is adjusted to have the beam waist diameter of 1.5 to 2.6 times of the signal laser light by the beam diameter adjustment optical systems 315, 316, the amplification light output from the PPLN crystal 303 has approximately the same divergence angle as the signal laser light transmitted through PPLN the crystal 303 (amplification light from the PPLN crystal 302).

Idler light output from the PPLN crystal 303 is transmitted through the dichroic mirror DM8 and absorbed by the damper 334. The amplification light and the transmission signal laser light output from the PPLN crystal 303 are reflected by the dichroic mirror DM8 and output from the amplification system 32 via the mirror MR5. Operation of the wavelength conversion system 50 thereafter is similar to that in the first embodiment. Although an example in which optical parametric amplification is performed in three stages has been described in FIG. 6, a configuration in which multi-stage amplification with four or more stages is performed may be employed.

### 4.3 Effect

According to the second embodiment, the number of OPA stages is increased and laser light having a wavelength of about 1553 nm with a higher power can be obtained while suppressing damages to the PPLN crystals.

### 5. First Modification of Beam Diameter Adjustment Optical System

### 5.1 Configuration

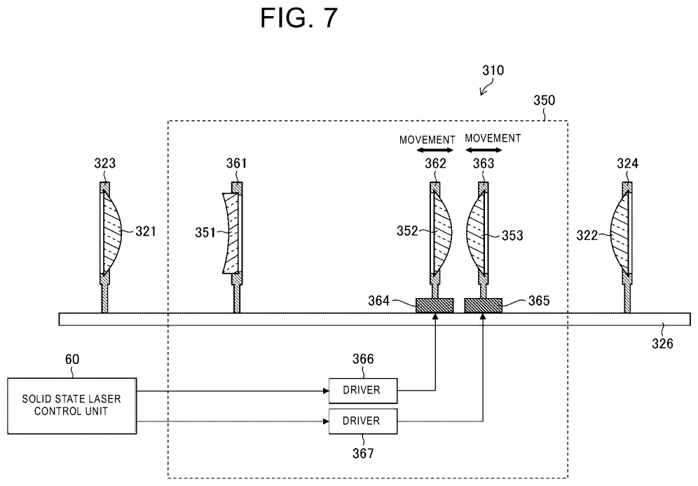

FIG. 7 schematically shows a first modification of the beam diameter adjustment optical system. In place of the beam diameter adjustment optical system 311 of the lens pair described in FIG. 3, a beam diameter adjustment optical system 310 shown in FIG. 7 may be applied. The configuration of the beam diameter adjustment optical system 310 may be applied to one or more of the beam diameter adjustment optical systems 311 to 316 shown in FIGS. 2 and 6. The configuration of FIG. 7 will be described in terms of differences from the configuration of FIG. 3.

In the beam diameter adjustment optical system 310, a variable beam expander 350 having a variable magnification is arranged between an opposing lens pair (the lens 321 and the lens 322). The variable beam expander 350 includes lenses 351, 352, 353, lens holders 361, 362, 363, and one-axis stages 364, 365 that are movable parallel to the optical axis. The one-axis stages 364, 365 may be linear stages and include drivers 366, 367, respectively. The one-axis stages 364, 365 are driven via the drivers 366, 367 by commands from the solid state laser control unit 60, and are configured to adjust the inter-lenses distance of the lenses 351, 352, 353. Each of the one-axis stages 364, 365 is an example of the “lens movement mechanism” in the present disclosure.

The lens 351 is held by the lens holder 361 and is arranged on the base plate 326. The lens 351 may be a concave lens. The lens 352 and the lens 353 are held by the lens holders 362, 363 and fixed to the one-axis stages 364, 365, respectively. The one-axis stages 364, 365 are arranged on the base plate 326. Each of the lens 352 and the lens 353 may be a convex lens.

Although FIG. 7 shows the variable beam expander 350 using the three lenses 351, 352, 353, the variable beam expander 350 may include four or more lenses.

### 5.2 Operation

The solid state laser control unit 60 transmits commands to the drivers 366, 367 to move the one-axis stages 364, 365 parallel to the optical axis to control positions of the lenses 352, 353. This allows the magnification of the beam to be adjusted while maintaining beam collimation.

### 5.3 Effect

Since the beam diameter adjustment optical system 310 shown in FIG. 7 configures a zoom system, adjustment of changing the beam waist diameter can be easily performed without changing the beam waist position.

### 5.4 Control Example

The positions of the one-axis stages 364, 365 may be controlled by inputting, to the solid state laser control unit 60, an output from a beam diameter monitor such as a beam profiler (not shown) that monitors the beam diameters of the pump laser light and the signal laser light in optical paths for performing optical parametric amplification in a plurality of stages. For example, the positions of the one-axis stages 364, 365 may be controlled so that the pump laser light and the signal laser light have approximately the same beam waist diameter in the PPLN crystal 301, and that the beam waist diameter of the pump laser light in the PPLN crystal 302 is 1.5 to 2.6 times of the beam waist diameter of the signal laser light in the PPLN crystal 302.

With such a configuration, since the beam diameter adjustment optical system 310 can be controlled, the proper beam waist diameter in each crystal can always be maintained even if there is a fluctuation in the system due to a thermal load or the like.

### 6. Second Modification of Beam Diameter Adjustment Optical System

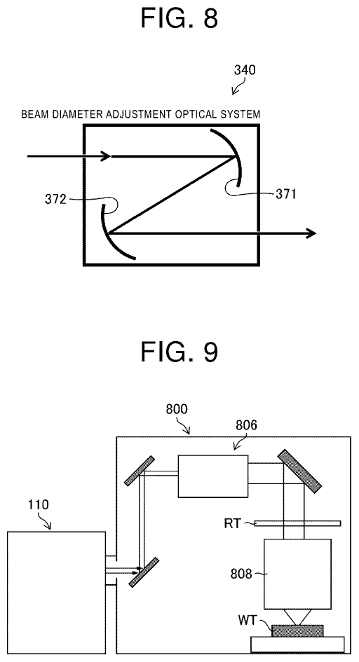

FIG. 8 schematically shows a second modification of the beam diameter adjustment optical system. In place of the beam diameter adjustment optical system 311 configured using the lens pair described in FIG. 3, a beam diameter adjustment optical system 340 shown in FIG. 8 may be applied. The beam diameter adjustment optical system 340 may be applied to one or more of the beam diameter adjustment optical systems 311 to 316 shown in FIGS. 2 and 6. The beam diameter adjustment optical system 340 includes a mirror optical system including a plurality of concave mirrors 371, 372, in place of a lens pair. According to the beam diameter adjustment optical system 340, it is possible to suppress the thermal lens effect caused by absorption of laser light by a lens.

### 7. Laser System Using Excimer Amplifier

The solid state laser system 10 including the laser system 100 described in the first embodiment or the second embodiment may be used in combination with an excimer amplifier (not shown).

That is, the laser system 100 may be configured to output amplified pulse laser light from the excimer amplifier by inputting pulse laser light of ultraviolet rays output from the solid state laser system 10 to the excimer amplifier as seed light.

The excimer amplifier may be, for example, a multipass amplifier in which pulse laser light passes through a discharge space in a chamber enclosing an excimer laser gas a plurality of times (e.g., three times) to perform amplification, or may be an amplifier including an optical resonator such as a Fabry-Perot resonator or a ring resonator.

### 8. Electronic Device Manufacturing Method

FIG. 9 schematically shows a configuration example of the exposure apparatus 800. The exposure apparatus 800 includes an illumination optical system 806 and a projection optical system 808. A laser system 110 is a laser system including the solid state laser system 10 described in the first embodiment and the second embodiment. The laser system 110 may be configured by combining the solid state laser system 10 and the excimer amplifier. The laser system 110 is used to generate and output ultraviolet laser light to the exposure apparatus 800. The illumination optical system 806 illuminates a reticle pattern of a reticle (not shown) arranged on a reticle stage RT with laser light incident from the laser system 110. The projection optical system 808 causes the laser light transmitted through the reticle to be imaged as being reduced and projected on a workpiece (not shown) arranged on a workpiece table WT. The workpiece is a photosensitive substrate such as a semiconductor wafer on which photoresist is applied.

The exposure apparatus 800 synchronously translates the reticle stage RT and the workpiece table WT in opposite directions to expose the workpiece to the laser light reflecting the reticle pattern. After the reticle pattern is transferred onto the semiconductor wafer by the exposure process described above, a semiconductor device can be manufactured through a plurality of processes. The semiconductor device is an example of the “electronic device” in the present disclosure.

### 9. Others

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious to those skilled in the art that the embodiments of the present disclosure would be appropriately combined.

The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.” Further, “at least one of A, B, and C” should be interpreted to mean any of A, B, C, A+B, A+C, B+C, and A+B+C as well as to include combinations of any thereof and any other than A, B, and C.

What is claimed is:

1. A laser system comprising:
a pump laser device configured to output pump laser light having a first wavelength;
a signal laser device configured to output signal laser light having a second wavelength longer than the first wavelength; and
an amplification system including a plurality of optical parametric crystals configured to transmit the pump laser light and the signal laser light and output amplification light having the second wavelength,
the plurality of optical parametric crystals including a first optical parametric crystal and a second optical parametric crystal arranged in series with the first optical parametric crystal, and
the amplification system:
being arranged such that beam waist positions of first amplification light, output from the first optical parametric crystal, incident on the second optical parametric crystal, and having the second wavelength and the pump laser light incident on the second optical parametric crystal coincide with each other, and that the first amplification light and the pump laser light are coaxially incident on the second optical parametric crystal, and
including a first beam diameter adjustment optical system in which a ratio of a beam waist diameter of the pump laser light in the second optical parametric crystal with respect to a beam waist diameter of the first amplification light in the second optical parametric crystal is set larger than a ratio of a beam waist diameter of the pump laser light in the first optical parametric crystal with respect to a beam waist diameter of the signal laser light in the first optical parametric crystal.

2. The laser system according to claim 1,
wherein the amplification system:
is arranged such that beam waist positions of the signal laser light incident on the first optical parametric crystal and the pump laser light incident on the first optical parametric crystal coincide with each other, and that the signal laser light and the pump laser light are coaxially incident on the first optical parametric crystal, and
includes a second beam diameter adjustment optical system in which the beam waist diameter of the signal laser light in the first optical parametric crystal and the beam waist diameter of the pump laser light in the first optical parametric crystal are set to be the same.

3. The laser system according to claim 1,
wherein the ratio of the beam waist diameter of the pump laser light in the second optical parametric crystal with respect to the beam waist diameter of the first amplification light in the second optical parametric crystal is in a range of 1.5 to 2.6 times.

4. The laser system according to claim 1,
wherein the first beam diameter adjustment optical system includes:
a third beam diameter adjustment optical system arranged on an optical path between the first optical parametric crystal and the second optical parametric crystal, and configured to adjust the beam waist diameter of the first amplification light, and
a fourth beam diameter adjustment optical system arranged on an optical path of the pump laser light, and configured to adjust the beam waist diameter of the pump laser light incident on the second optical parametric crystal.

5. The laser system according to claim 1,
wherein a divergence angle of second amplification light output from the second optical parametric crystal and having the second wavelength is 0.8 time or more and 1.2 times or less a divergence angle of the first amplification light transmitted through the second optical parametric crystal and output from the second optical parametric crystal.

6. The laser system according to claim 2,
wherein the second beam diameter adjustment optical system includes:
a fifth beam diameter adjustment optical system arranged on an optical path of the signal laser light incident on the first optical parametric crystal, and configured to adjust the beam waist diameter of the signal laser light, and
a sixth beam diameter adjustment optical system arranged on an optical path of the pump laser light, and configured to adjust the beam waist diameter of the pump laser light incident on the first optical parametric crystal.

7. The laser system according to claim 2,
wherein the beam waist positions of the signal laser light incident on the first optical parametric crystal and the pump laser light incident on the first optical parametric crystal are set to be located at a center part of the first optical parametric crystal, and
the beam waist positions of the first amplification light incident on the second optical parametric crystal and having the second wavelength and the pump laser light incident on the second optical parametric crystal are set to be located at a center part of the second optical parametric crystal.

8. The laser system according to claim 1,
wherein the amplification system is:
configured with the plurality, three or more, of optical parametric crystals including the first optical parametric crystal and the second optical parametric crystal arranged in series, and
configured to perform optical parametric amplification in a plurality, three or more, of stages by the plurality of optical parametric crystals with the first optical parametric crystal serving for a first stage of amplification stages.

9. The laser system according to claim 8,
wherein a ratio of the beam waist diameter of the pump laser light with respect to a beam waist diameter of amplification light having the second wavelength in each optical parametric crystal arranged in stages later than the first optical parametric crystal is in a range of 1.5 to 2.6 times.

10. The laser system according to claim 1,
wherein the plurality of optical parametric crystals are arranged in series, and the beam waist diameter of the pump laser light incident on each of the optical parametric crystals in which optical parametric amplification is performed in a plurality of stages is set in a manner that the beam waist diameter of the pump laser light incident on the optical parametric crystal arranged in a relatively later stage in the series arrangement is larger.

11. The laser system according to claim 10,
wherein an optical parametric crystal arranged in a relatively later stage in the series arrangement of the plurality of optical parametric crystals has a larger crystal cross-sectional area perpendicular to an optical axis of the pump laser light than an optical parametric crystal arranged in a relatively earlier stage.

12. The laser system according to claim 1,
wherein the first beam diameter adjustment optical system includes a variable beam expander having a variable magnification arranged between an opposing lens pair, and
the variable beam expander includes three or more lenses, and a lens movement mechanism configured to change an inter-lenses distance of the three or more lenses.

13. The laser system according to claim 2,
wherein the second beam diameter adjustment optical system includes a variable beam expander having a variable magnification arranged between an opposing lens pair, and
the variable beam expander includes three or more lenses, and a lens movement mechanism configured to change an inter-lenses distance of the three or more lenses.

14. The laser system according to claim 1,
wherein the first beam diameter adjustment optical system includes a mirror optical system including a plurality of concave mirrors.

15. The laser system according to claim 2,
wherein the second beam diameter adjustment optical system includes a mirror optical system including a plurality of concave mirrors.

16. The laser system according to claim 1,
further comprising a wavelength conversion system configured to receive amplification light output from the amplification system and having the second wavelength and ultraviolet light, and output sum frequency thereof.

17. The laser system according to claim 16,
further comprising a non-linear optical crystal configured to receive the pump laser light having the first wavelength and perform wavelength conversion into the ultraviolet light which is harmonic light.

18. The laser system according to claim 16,
wherein the wavelength conversion system includes a plurality of non-linear optical crystals arranged in series, and performs sum frequency generation for a plurality of times by the plurality of non-linear optical crystals.

19. The laser system according to claim 1,
wherein the pump laser device includes a first semiconductor laser configured to output first continuous wave laser light having the first wavelength, and a first solid state amplifier configured to perform pulsing and amplification on the first continuous wave laser light,
pulse laser light output from the first solid state amplifier and having the first wavelength is used as the pump laser light,
the signal device laser includes a second semiconductor laser configured to output second continuous wave laser light having the second wavelength, and a second solid state amplifier configured to perform amplification on the second continuous wave laser light, and
continuous wave laser light output from the second solid state amplifier and having the second wavelength is used as the signal laser light.

20. An electronic device manufacturing method, comprising:
generating laser light having a second wavelength using a laser system;
generating ultraviolet laser light by performing wavelength conversion on the laser light having the second wavelength;
outputting the ultraviolet laser light to an exposure apparatus; and
exposing a photosensitive substrate to the ultraviolet laser light in the exposure apparatus to manufacture an electronic device,
the laser system including:
a pump laser device configured to output pump laser light having a first wavelength;
a signal laser device configured to output signal laser light having the second wavelength longer than the first wavelength; and
an amplification system including a plurality of optical parametric crystals configured to transmit the pump laser light and the signal laser light and output amplification light having the second wavelength,
the plurality of optical parametric crystals including a first optical parametric crystal and a second optical parametric crystal arranged in series with the first optical parametric crystal, and
the amplification system:
being arranged such that beam waist positions of first amplification light, output from the first optical parametric crystal, incident on the second optical parametric crystal, and having the second wavelength and the pump laser light incident on the second optical parametric crystal coincide with each other, and that the first amplification light and the pump laser light are coaxially incident on the second optical parametric crystal, and
including a first beam diameter adjustment optical system in which a ratio of a beam waist diameter of the pump laser light in the second optical parametric crystal with respect to a beam waist diameter of the first amplification light in the second optical parametric crystal is set larger than a ratio of a beam waist diameter of the pump laser light in the first optical parametric crystal with respect to a beam waist diameter of the signal laser light in the first optical parametric crystal.
